(19) United States
(12) Patent Application Publication
(10) Pub. No.: US 2017/0362450 A1
(43) Pub. Date: Dec. 21, 2017

(54) Inks

(71) Applicant: Fujifilm Imaging Colorants, Inc., New Castle, DE (US)

(72) Inventors: Christopher Oriakhi, New Castle, DE (US); Ravi Shankar, New Castle, DE (US); Philip John Double, Manchester (GB)

(21) Appl. No.: 15/534,082

(22) PCT Filed: Dec. 10, 2015
(86) PCT No.: PCT/GB2015/053784

§ 371 Date: Jun. 8, 2017

Related U.S. Application Data
(60) Provisional application No. 62/090,928, filed on Dec. 12, 2014.

(51) Int. Cl. C09D 11/102; C09D 11/322; C09D 11/106; C08L 75/04; C08L 71/02; C09D 11/38; C08L 9/08

(52) U.S. Cl. CPC C09D 11/102; C09D 11/38; C09D 11/322; C08L 9/08; C08L 75/04; C08L 71/02; C09D 11/106

(57) ABSTRACT

An ink comprising: (a) from 1 to 25 parts of titanium dioxide pigment; (b) from 0 to 8 parts of a styrene butadiene latex binder; (c) from 0 to 8 parts of a polyurethane latex binder; (d) from 0 to 5 parts of a glycol selected from the group consisting of ethylene glycol, diethylene glycol, propylene glycol, dipropylene glycol or triethylene glycol; (e) from 1 to 10 parts of 2-pyrrolidone; (f) from 1 to 10 parts of glycerol; (g) from 0.01 to 2 parts of an acetylenic surfactant; (h) from 0.001 to 5 parts of biocide; (i) from 0 to 10 parts of a viscosity modifier; and (j) the balance to 100 parts water; provided that (b) plus (c) is greater than 0. Also ink jet printing processes, ink-jet ink containers, printed substrates and ink-jet printers.

This invention relates to white inks, a process for ink-jet printing, ink-jet ink containers and ink-jet printers.

White inks are used to provide good visibility when printed on transparent and coloured surfaces. White printing on these surfaces is desirable in numerous end uses, such as the computer industry (printed circuit boards, computer chips), recording industry (tapes, film, etc.), packaging and automotive coatings. White ink is used not only to detail and add decals to automobiles, but also to other motor vehicles, including trucks, planes and trains, as well as bicycles, etc. White ink can also be useful on other surfaces, such as plastics, wood, metal, glass, textiles, polymeric films and leather for both practical and ornamental purposes. In these applications it is particularly important that the white ink when printed shows an excellent resistance and durability in damp conditions and oily conditions.

A preferred means of applying white ink is by ink-jet printing.

Ink-jet printing is a non-impact printing technique in which droplets of an ink are ejected through fine nozzles onto a substrate without bringing the nozzles into contact with the substrate. There are basically three types of ink-jet printing:
i) Continuous ink-jet printing uses a pressurized ink source that produces a continuous stream of ink droplets from a nozzle. The droplets of ink are directed either thermally or by electrostatic means at a nominally constant distance from the nozzle. Those droplets which are not successfully deflected are recycled to the ink reservoir via a gutter.
ii) Drop-on-demand ink-jet printing where the ink is stored in a cartridge and fired from the print-head nozzle using a pressurization actuator (usually thermal or piezoelectric). With drop-on-demand printing only the drops that are required for printing are produced.
iii) Re-circulating ink-jet printing where the ink is continuously re-circulated in the print-head and (as in drop-on demand printing) only drops required for printing are drawn off to the nozzle.

Each of these types of ink-jet printing presents unique challenges. Thus, in continuous ink-jet printing ink active solvent monitoring and regulation is required to counter solvent evaporation during the time of flight (time between nozzle ejection and gutter recycling), and from the venting process whereby excess air (drawn into the reservoir when recycling unused drops) is removed.

In drop-on demand printing the ink may be kept in the cartridge for long periods when it can deteriorate and form precipitates which can, in use, block the fine nozzles in the print-head. This problem is particularly acute with pigment inks where the suspended pigment can settle out.

Re-circulating ink-jet printing avoids these problems. Since the ink is constantly circulating it lessens the chance of precipitates forming and as the ink is only removed to the nozzle as required solvent evaporation is minimised.

Re-circulating ink-jet printers have found particular utility in the industrial sector. Industrial ink-jet printers are required to work at high speeds. Optimally a print-head for an industrial ink-jet printer will have multiple nozzles arranged at a high density to enabling single-pass printing.

Ink formulation for all forms of ink-jet printing is extremely demanding. It is especially difficult to formulate inks able to work in these high speed single pass print-heads. To enable these printers to work at these high speeds the inks used must show a low foaming potential and excellent drop formation.

There are particular problems associated with the use of white inks in ink-jet printing. For example, titanium dioxide is a common white ink pigment and is generally three to four times heavier than pigments used in other colored inks. Thus, pigments such as titanium dioxide have a much greater tendency to precipitate and clog the nozzles of inkjet systems.

One means of stabilising a titanium dioxide containing ink is to increase its viscosity. However such inks have to be diluted prior to jetting.

The present inventors have devised an ink formulation which is viscous enough to prevent the titanium dioxide pigment from precipitating but which does not need to be diluted prior to jetting.

Therefore, according to a first aspect of the present invention there is provided an ink comprising:
(a) from 1 to 25 parts of titanium dioxide pigment;
(b) from 0 to 8 parts of a styrene butadiene latex binder;
(c) from 0 to 8 parts of a polyurethane latex binder;
(d) from 0 to 5 parts of a glycol selected from the group consisting of ethylene glycol, diethylene glycol, propylene glycol, dipropylene glycol or triethylene glycol;
(e) from 1 to 10 parts of 2-pyrrolidone;
(f) from 1 to 10 parts of glycerol;
(g) from 0.01 to 2 parts of an acetylenic surfactant;
(h) from 0.001 to 5 parts of biocide;
(i) from 0 to 10 parts of a viscosity modifier; and
(j) the balance to 100 parts water; provided that (b) plus (c) is greater than 0.

All parts and percentages herein (unless stated otherwise) are by weight.

The titanium dioxide present in the surface treated titanium dioxide pigment may be in rutile or anatase form or a mixture of the two forms.

Preferably the titanium dioxide pigment comprises a surface treated titanium dioxide pigment.

The titanium dioxide pigment particles can have a wide variety of average particle sizes of about 1 micron or less, depending on the desired end use application of the ink.

The titanium dioxide pigment is in and of itself white in color.

For applications demanding high hiding or decorative printing applications, the titanium dioxide particles preferably have a Z average mean particle diameter of less than 1 micron (1000 nm). Preferably, the particles have a Z average mean particle diameter of from 50 to 950 nm, more preferably from 75 to 750 nm, and still more preferably from 100 to 500 nm. It is especially preferred that the titanium dioxide particles have a Z average mean particle diameter of from 125 to 350 nm and more especially of from 150 to 300 nm. The Z average mean particle diameter may be readily measured using a Zetasizer® from Malvern Instruments. Titanium dioxide particles of this size are commonly called pigmentary titanium dioxide.

For applications demanding white color with some degree of transparency, the pigment preference is “nano” titanium dioxide. “Nano” titanium dioxide particles typically have a Z average mean particle diameter ranging from about 10 to about 200 nm, preferably from about 20 to about 150 nm, and more preferably from about 35 to about 75 nm. An ink comprising nano titanium dioxide can provide improved chroma and transparency, while still retaining good resistance to light fade and an appropriate hue angle.

In addition, unique advantages may be realized with multiple particle sizes, such as opaqueness and UV protection. These multiple sizes can be achieved by adding both a pigmentary and a nano grade of titanium dioxide.

The Zetasizer polydispersity index, measured using a Zetasizer from Malvern Instruments, of the titanium dioxide particles in the ink is preferably less than 0.2. The titanium dioxide pigment is preferably incorporated into an ink formulation via a slurry concentrate composition. The amount of titanium dioxide present in the slurry composition is preferably from about 20 wt % to about 80 wt %, based on the total slurry weight.

The titanium dioxide pigment may be substantially pure titanium dioxide or may comprise other metal oxides. These other metal oxides are preferably one or more selected from the group consisting of silica, alumina, zirconia and mixtures thereof. Other metal oxides may become incorporated into the pigment particles, for example, by co-oxidizing or co-precipitating titanium compounds with other metal compounds. If the titanium dioxide pigment comprises co-oxidized or co-precipitated metals, they are preferably present as the metal oxide in an amount from 0.1 wt % to 20 wt %, more preferably from 0.5 wt % to 5 wt %, and still more preferably from 0.5 wt % to 1.5 wt %, based on the total titanium dioxide pigment weight.

In a preferred embodiment the surface of the surface treated titanium dioxide pigment is coated with an inorganic compound selected from the group consisting of silica, alumina, alumina-silica or zirconia. More preferably the surface of the surface treated titanium dioxide is treated with alumina, silica or a mixture thereof. Such coatings may be present in an amount of from 0.1 wt % to 10 wt %, and preferably from 0.5 wt % to 3 wt %, based on the total weight of the titanium dioxide.

The surface of the surface treated titanium dioxide may also carry one or more organic surface coatings. The organic surface coatings are, for example, selected from the group consisting of carboxylic acids, silanes, siloxanes and hydrocarbon waxes, and their reaction products. The amount of organic surface coating generally ranges from 0.01 wt % to 6 wt %, preferably from 0.1 wt % to 3 wt % and more preferably from 0.5 wt % to 1.5 wt % based on the total weight of the titanium dioxide.

Preferred surface treatments for the surface treated titanium dioxide include alumina, silicate, methicone, polydimethylsiloxyethyl dimethicone, triethoxysilylethyl polydimethylsiloxyethyl dimethicone, PEG-10 dimethicone, PEG-9 polydimethylsiloxyethyl dimethicone, PEG-8 methyl ether triethoxysilane, isopropyl titanium triisostearate and triethoxycaprylylsilane. The surface treatments for the surface treated titanium dioxide can also be a hybrid treatments such as polyhydroxystearic acid and silane (especially triethoxycaprylylsilane and polyhydroxystearic acid), isopropyl titanium triisostearate and alumina and triethoxysilylethyl polydimethylsiloxyethyl dimethicone, isopropyl titanium triisostearate and triethoxysilylethyl polydimethylsiloxyethyl dimethicone.

In one preferred embodiment the surface treated titanium dioxide pigment is treated so it has a hydrophilic character.

In a preferred embodiment the surface of the surface treated titanium dioxide pigment is treated with alumina, silica or a mixture thereof.

Preferably the surface treated titanium dioxide is a cosmetic grade material.

The titanium dioxide pigment is preferably present in the range of from 2 to 23 parts and more preferably of from 5 to 20 parts.

The ink may contain more than one styrene butadiene latex binder (component (b)). The latex binders may differ in their properties, such as particle size, glass transition temperature or molecular weight.

Preferably the styrene butadiene latex binder has a Tg in the range of from 0° C. to 120° C., more preferably in the range of from 10° C. to 110° C. and especially in the range of from 50° C. to 90° C.

The Tg is determined by Differential Scanning Calorimetry on the dried latex. The Tg is taken as being the midpoint value from a re-heat Differential Scanning Calorimetry scan (i.e. after an initial heat and cool).

Preferably the styrene butadiene latex binder are prepared by emulsion polymerisation.

The molecular weight of the styrene butadiene latex binder can be controlled by methods known in the art, for example, by use of a chain transfer agent (e.g. a mercaptan) and/or by control of initiator concentration in the case of emulsion polymerisation, and/or by heating time. Preferably the styrene butadiene latex binder has a molecular weight of greater than 20,000 Daltons and more preferably of greater than 100,000 Daltons. It is especially preferred that the molecular weight of the styrene butadiene latex binder is greater than 200,000 more especially greater than 500,000 Daltons.

The styrene butadiene latex binder may be monomodal, preferably with an average particle size of below 1000 nm, more preferably below 200 nm and especially below 150 nm. Preferably, the average particle size of the styrene butadiene latex binder is at least 20 nm, more preferably at least 50 nm. Thus, the styrene butadiene latex binder may preferably have an average particle size in the range of from 20 to 200 nm and more preferably in the range of from 50 to 150 nm. The average particle size of the styrene butadiene latex binder may be measured using photon correlation spectroscopy

The styrene butadiene latex binder may also show a bimodal particle size distribution. This may be achieved either by mixing two or more latexes of different particle size, or by generating the bimodal distribution directly, for example by two-stage polymerisation. Where a bimodal particle size distribution is used it is preferred that the lower particle size peak is in the range 20-80 nm, and the higher particle size peak is in the range 100-500 nm. It is further preferred that the ratio of the two particle sizes is at least 2, more preferably at least 3 and most preferably at least 5.

The molecular weight of the styrene butadiene latex binder may be determined by Gel Permeation Chromatography against polystyrene standards using an Agilent HP1100 instrument with THF as eluent and PL Mixed Gel C columns.

The styrene butadiene latex binder once formed is preferably screened to remove oversized particles prior to use, for example through a filter having an average pore size below 3 μm, preferably 0.3 to 2 μm, especially 0.5 to 1.5 μm. The styrene butadiene latex binder may be screened before, during or after it is mixed with other components to form the ink.

Commercially available styrene butadiene latex binders may be used in the ink according to the present invention.

Examples of commercially available styrene butadiene latex binders which can be used in the ink of the pre present invention include styrene butadiene latexes in the Rovene® range supplied by Mallard Creek polymers Rovene 5499 and Rovene 4111 and especially Rovene 4111.

Component (b) is preferably in the range of from 2 to 6 parts.

Component (c) is the polyurethane latex binder.

Polyurethane dispersions are typically made by:
(i) reaction of a polymeric diol (polyol), and optionally other components capable of reacting with isocyanate groups, with a di-isocyanate to create a pre-polymer, followed by;
(ii) dispersion into water optionally with chain-extension of the prepolymer by reaction with water and/or a chain-extender present in the water phase;

The dispersion may be stabilised by monomers present in the polyurethane, for example ionic groups or non-ionic groups, or by added surfactants.

The Tg of the polyurethane latex binder may be controlled through the selection of the polyol, the di-isocyanate and the chain extender. It is also possible to control the Tg of the polyurethane binder latex by mixing batches of latex with a different Tg.

Preferably the polyurethane latex binder has a Tg in the range of from −30° C. to 0° C.

The weight average molecular weight of the polyurethane is preferably >20,000, more preferably >50,000 and most preferably >100,000.

The polyurethane latex binder preferably has an average particle size of below 1000 nm, more preferably below 200 nm and especially below 150 nm. Preferably, the average particle size of the latex binder is at least 20 nm, more preferably at least 50 nm. Thus, the latex binder may preferably have an average particle size in the range of from 20 to 200 nm and more preferably in the range of from 50 to 150 nm. The average particle size of the latex binders may be measured using photon correlation spectroscopy.

Commercially available polyurethane latex binders include W835/177 and W835/397 from Incorez, Joncryl® U4190 from BASF, Sancure® 20025F and Sancure 2710 from Lubrizol.

Component (c) is preferably present in the range of from 2 to 6 parts.

In one preferred embodiment component (b) is a styrene butadiene latex binder and component (c) is 0.

In a second preferred embodiment component (b) is 0.

Preferably the ink contains either component (b) in the range of from 2 to 6 parts or component (c) in the range of from 2 to 6 parts

The latex components (b) and (c) plays a key role in the improved adhesion seen with the inks of the present invention when applied to low surface energy substrates and to the durability of the print in wet and oily conditions.

In one embodiment component (d) is preferably ethylene glycol.

In a second embodiment component (d) is preferably triethylene glycol

Component (d) is preferably present in the range of from 0.5 to 2.5 parts and more preferably in the range of from 0.75 to 2.0 parts.

Component (e) is preferably present in the range of from 2.5 to 7.5 parts.

Component (f) is preferably present in the range of from 2 to 7.5 parts.

Component (g) is preferably 2,4,7,9-tetramethyl-5-decyne-4,7-diol which is commercially available as Surfynol® 440 from Air Products or as its ethoxylated analogue Surfynol® 465.

Mixtures containing different surfactants may be used.

The surfactant is a key component in the inks of the present invention. Correct choice of both the surfactant and its concentration in a particular ink is essential in the ink-jetting effectively and in not wetting the face-plate of the print-head.

It is desirable that the ink is designed so that it does not wet print-head face-plates that are not treated with a “non-wetting coating”. These face-plates may show a contact angle with water of less than 90°, or less than 80°. Face-plates that are specifically designed to be non-wetting may have a contact angle with water of more than 90° C., sometimes more than 95°, and sometimes even more than 100°.

To achieve these properties it is desirable that the ink shows a dynamic surface tension range, i.e. that its surface tension is dependent on the surface age. The surface tension of a newly created surface is high, but drops as surfactant, or other surface active species, migrate to the surface. The dynamic surface tension range may be determined by measurements in a bubble tensiometer. This measures the surface tension as a function of surface age or bubble frequency. It is preferred that the surface tension measured at 5 ms (γ(5)) is >35 dynes/cm, and the surface tension measured at 1,000 ms (γ(1000)) is in the range 20 to 40 dynes/cm, with γ(10)>γ(1000). Alternatively the equilibrium surface tension of the ink can be compared with that of the equivalent ink made without inclusion of the surfactant(s). It is preferred that the equilibrium surface tension without surfactant is at least 10 dynes/cm higher than that where the surfactant(s) is (or are) present.

For component (h) any biocide (or mixture of biocides) which is stable in the ink may be used. It is particularly preferred that the biocide comprises 1,2-benzisothazolin-3-one which is available as a 20% active solution from Lonza as Proxel® GXL or Bioban®, DXN (2,6-dimethyl-1,3-dioxan-4-yl acetate), from Dow Chemical Company.

The viscosity modifier, component (i), is preferably selected from the group consisting of polyethers, (such as polyethylene glycol and poly(ethylene oxide)), cellulose polymers such as hydroxyethyl cellulose, hydroxypropyl cellulose and carboxymethyl cellulose, water-soluble polyesters, homopolymers of 2-ethyl-oxazoline (e.g. poly-2-ethyl-2-oxazoline), poly(vinyl alcohol) and poly(vinylpyrrolidones) and mixtures thereof.

Component (i) is preferably poly(ethylene glycol) or poly(ethylene oxide). More preferably component (h) is polyethylene glycol especially polyethylene glycol 20,000.

Component (i) is preferably present in the composition in an amount of from 3 to 8 parts.

The ink preferably has a MFFT below 65° C., especially below 60° C.

The MFFT is the lowest temperature at which components of the ink components will coalesce to form a film, e.g. during ink drying.

Equipment for measuring MFFT is commercially available, for example the Minimum Film Forming Temperature Bar is available from Rhopoint Instruments (the “MFFT Bar 90”). The MFFT Bar 90 comprises a temperature bar having a nickel-plated copper platen with an electronically imposed temperature gradient. Ten equally spaced sensors beneath the surface provide instantaneous temperature measurement along the bar. The desired temperature program is selected and the instrument allowed to reach thermal equilibrium. Tracks of wet test ink may be applied using a cube applicator, or spreader. Once the ink has dried the device shows the MFFT. If for any reason the above mentioned commercially available equipment does not work on the ink (e.g. due to a low latex content and/or the ink's colour), one may instead place a small amount of the ink in a dish and heat the dish containing the ink at the desired assessment temperature (e.g. 70° C.) for 24 hours and then rub the surface with a gloved finger to assess whether a film has formed. If a film has formed there will be little or no ink transfer to the gloved finger, whereas if a film has not formed there will be a significant transfer of ink to the gloved finger or the dried ink will crack.

The desired MFFT may be achieved by selecting appropriate combinations of polymer latex and organic solvents. If the MFFT of an ink is too high, the amount of coalescing solvent may be increased and/or a polymer latex of lower Tg may be used in order to bring the ink MFFT into the desired range. Therefore at the ink design stage one may decide whether to include more or less coalescing solvent and higher or lower Tg polymer latex, depending on the desired MFFT.

Typically one will select the ink and the substrate such that the ink has an MFFT below the temperature at which the substrate would deform, distort or melt. In this way, the ink can form a film on the substrate at a temperature which does not damage the substrate.

In a first preferred embodiment the viscosity of the ink at 32° C. is in the range of from 10 to 14 mPa s when measured using a Brookfield SC4-18 at 150 rpm.

In a second preferred embodiment the viscosity of the ink 1 at 32° C. is in the range of from 4 to 8 mPas when measured using a Brookfield SC4-18 at 150 rpm.

In the first preferred embodiment the ink has a surface tension of from 20 to 65 dynes/cm, more preferably of from 20 to 50 dynes/cm, especially of from 32 to 42 dynes/cm and more especially of from 34 to 38 dynes/cm, when measured at 25° C. using a Kruss K100 tensiometer.

In the second preferred embodiment the ink has a surface tension of from 20 to 65 dynes/cm, more preferably of from 20 to 50 dynes/cm and especially of from 30 to 40 dynes/cm, when measured at 25° C. using a Kruss K100 tensiometer

Preferably, the ink composition has been filtered through a filter having a mean pore size of less than 10 microns, more preferably less than 5 microns and especially less than 1 micron.

Preferably the ink has a pH in the range of from 7 to 9.5. The pH may be adjusted by means of a suitable buffer.

In addition to the above mentioned components, the ink composition may optionally comprise one or more ink additives. Preferred additives suitable for ink-jet printing inks are anti-kogation agents, rheology modifiers, corrosion inhibitors and chelating agents. Preferably, the total amount of all such additives is no more than 10 parts by weight. These additives are added to and comprise part of component (j), the water added to the ink.

In one preferred embodiment the ink comprises:
(a′) from 5 to 20 parts of titanium dioxide pigment;
(b′) from 2 to 6 parts of a styrene butadiene latex binder;
(c′) from 0.5 to 2.5 parts of ethylene glycol;
(d′) from 2.5 to 7.5 parts of 2-pyrrolidone;
(e′) from 2 to 7.5 parts of glycerol;
(f′) from 0.05 to 1.0 parts of 2,4,7,9-tetramethyl-5-decyne-4,7-diol;
(g′) from 0.001 to 2 parts of biocide;
(h′) from 3 to 8 parts of a viscosity modifier;
(i′) the balance to 100 parts water.

In a second preferred embodiment the ink comprises:
(a″) from 5 to 20 parts of titanium dioxide pigment;
(b″) from 2 to 6 parts of a polyurethane latex binder;
(c″) from 0.5 to 2.5 parts of ethylene glycol;
(d″) from 2.5 to 7.5 parts of 2-pyrrolidone;
(e″) from 2 to 7.5 parts of glycerol;
(f″) from 0.05 to 1.0 parts of 2,4,7,9-tetramethyl-5-decyne-4,7-diol;
(g″) from 0.001 to 2 parts of biocide;
(h″) from 3 to 8 parts of a viscosity modifier;
(i″) the balance to 100 parts water.

Although the present invention is of particular value for printing substrates which are non-absorbent and/or temperature-sensitive, it may also be used to print substrates which are absorbent and/or not temperature-sensitive. For such substrates the present inks and processes offer the advantage of providing prints having good rub-fastness properties at lower temperatures than used in prior processes, thereby reducing manufacturing costs.

Examples of non-absorbent substrates include polyester, polyurethane, bakelite, poly vinyl chloride, nylon, polymethyl methacrylate, polyethylene terephthalate, polypropylene, acrylonitrile-butadiene-styrene, polycarbonate, a blend of about 50% polycarbonate and about 50% acrylonitrile-butadiene-styrene, polybutylene terephthalate, rubber, glass, ceramic and metal.

Preferably the ink is used to print a substrate which comprises a spunbond film laminate, especially a polypropylene based spunbond film laminate.

It is particularly preferred that the ink is used to print non-woven wipes preferably comprising polypropylene and more preferably comprising a polypropylene based spunbond film laminate.

If desired the substrate may be pre-treated in order to enhance adhesion of the ink thereto, e.g. using plasma, corona discharge or surfactant treatment. For example the substrate may be roughened, or it may be coated with an ink receptive coating.

In one embodiment the process further comprises drying the ink applied to the substrate at a temperature of at most 70° C., more preferably of at most 65° C. and especially of at most 60° C.

A second aspect of the invention provides an ink-jet printing process wherein the ink according to the first aspect of the invention is printed onto a substrate by means of an ink jet printer. Preferably in the second aspect of the invention the ink according to the first aspect of the invention is printed onto a substrate using an ink-jet printer with an ink re-circulating print-head.

The process of the present invention may use any ink-jet printer with an ink re-circulating print-head. Preferably the print-head has an ink re-circulation channel in the ink supply system. This channel allows for fresh ink to be available for jetting and can be part of the ink supply system or even specially engineered channels which run behind the nozzle plate. It is preferred that the ink supply system runs behind the nozzle plate as this allows for the use of more volatile inks whilst not compromising restart/latency behaviour. Behind nozzle plate re-circulation is exemplified in commercially available FUJIFILM Dimatix print-heads such as Samba® or SG1024®.

Recirculating print-heads of the type preferred in the present invention are usually equipped with a reservoir heater and a thermistor to control the jetting temperature. Preferably in step (III) the jetting temperature is in excess of 30° C.

Preferably the drop volume of the ink applied by the ink-jet printer is in the range of from 1 to 100 pl.

When the ink of the first preferred embodiment, as described above in step (I) is jetted the drop volume of the ink applied by the ink-jet printer is preferably in the range of from 20 to 100 pl and more preferably in the range of from 20 to 40 pl and especially of from 25 to 35 pl.

When the ink of the second preferred embodiment, as described above in step (I) is jetted the drop volume of the ink applied by the ink-jet printer is preferably in the range of from 1 to 20 pl and more preferably in the range of from 2 to 8 pl.

A third aspect of the present invention provides a substrate printed by an ink-jet printing process as described in the second aspect of the invention using an ink as described in the first aspect of the invention. Thus the third aspect of the invention preferable provides a substrate printed with an the ink according to the first aspect of the invention using an ink-jet printer with an ink re-circulating print-head

The substrate is as described and preferred in the first aspect of the invention.

Thus, preferably the printed substrate is a substrate which comprises a spunbond film laminate, especially a polypropylene based spunbond film laminate.

More preferably the printed substrate comprises non-woven wipes preferably comprising polypropylene and more preferably comprising a polypropylene based spunbond film laminate.

According to a fourth aspect of the present invention there is provided an ink-jet printer ink container (e.g. a cartridge or a larger ink tank), containing an ink as defined in the first aspect of the present invention

A fifth aspect of the present invention provides an ink-jet printer with re-circulating print-head, as described in the second aspect of the invention, and an ink-jet printer ink container containing an ink, as described in the fourth aspect of the invention.

### EXAMPLES

The present invention will now be illustrated by the following examples in which all parts are by weight unless stated to the contrary.

Titanium dioxide 1 is GLW75PFSP from Kobo Products.

Titanium dioxide 2 is a Titania NanoDispersion from Evonik Industries

Surfynol® 440 is an acetylenic surfactant from Air Products.

Sancure® 20025F is an aliphatic polyester urethane polymer dispersion. from Lubrizol.

Rovene® 4111 is a styrene butadiene dispersion from Mallard Creek Polymers.

Rovene 6102 is a styrene acrylic dispersion from Mallard Creek Polymers.

1,2-Benzisothazolin-3-one was obtained as Proxel® GXL (20% solution) from Lonza.

### Example Ink 1

| Component | Formulation At 100% Active (Wt %) |
|---|---|
| Titanium Dioxide 1 | 12.0 |
| Glycerol | 3.75 |
| Ethylene glycol | 1.25 |
| 2 Pyrrolidone 95% | 5.0 |
| Surfynol 440 | 0.065 |
| 1,2-Benzisothazolin-3-one | 0.015 |
| Rovene 4111 | 4.0 |
| PEG 20K | 6.40 |
| DI Water | to 100 |

### Properties of Example Ink 1

| Properties | |
|---|---|
| Viscosity at 32° C. | 11.34 |
| Surface Tension D/cm | 34.74 |

### Example Ink 2

| Component | Formulation At 100% Active (Wt %) |
|---|---|
| Titanium Dioxide 1 | 10.0 |
| Titanium Dioxide 2 | 4.0 |
| Glycerol | 3.75 |
| Ethylene glycol | 1.25 |
| 2 Pyrrolidone 95% | 5.0 |
| Surfynol 440 | 0.065 |
| 1,2-Benzisothazolin-3-one | 0.015 |
| Rovene 4111 | 4.0 |
| PEG 20K | 6.10 |
| DI Water | to 100 |

### Properties of Example Ink 2

| Properties | |
|---|---|
| Viscosity at 32° C. | 12.56 |
| Surface Tension D/cm | 35.13 |

### Example Ink 3

| Component | Formulation At 100% Active (Wt %) |
|---|---|
| Titanium Dioxide 1 | 12.0 |
| Glycerol | 3.75 |
| Ethylene glycol | 1.25 |
| 2 Pyrrolidone 95% | 5.0 |
| Surfynol 440 | 0.030 |
| 1,2-Benzisothazolin-3-one | 0.015 |
| Sancure 20025F | 4.0 |
| PEG 20K | 5.4 |
| DI Water | to 100 |

### Properties of Example Ink 3

| Properties | |
|---|---|
| Viscosity at 32° C. | 11.56 |
| Surface Tension D/cm | 34.43 |

### Example Ink 4

| Component | Formulation At 100% Active (Wt %) |
|---|---|
| Titanium Dioxide 1 | 10.0 |
| Titanium Dioxide 2 | 4.0 |
| Glycerol | 3.75 |
| Ethylene glycol | 1.25 |
| 2 Pyrrolidone 95% | 5.0 |
| Surfynol 440 | 0.030 |
| 1,2-Benzisothazolin-3-one | 0.015 |
| Sancure 20025F | 4.0 |
| PEG 20K | 5.40 |
| DI Water | to 100 |

### Properties of Example Ink 4

| Properties | |
|---|---|
| Viscosity at 32° C. | 11.56 |
| Surface Tension D/cm | 35.5 |

### Comparative Example Ink 1

| Component | Formulation At 100% Active (Wt %) |
|---|---|
| Titanium Dioxide 1 | 12.0 |
| Glycerol | 3.75 |
| Ethylene glycol | 1.25 |
| 2 Pyrrolidone 95% | 5.0 |
| Surfynol 440 | 0.6 |
| 1,2-Benzisothazolin-3-one | 0.015 |
| Acrylic latex | 4.0 |
| PEG 20K | 5.80 |
| DI Water | to 100 |

### Properties of Comparative Example Ink 1

| Properties | |
|---|---|
| Viscosity at 32° C. | 12.78 |
| Surface Tension D/cm | 33.00 |

### Comparative Example Ink 2

| Component | Formulation At 100% Active (Wt %) |
|---|---|
| Titanium Dioxide 1 | 10.0 |
| Titanium Dioxide 2 | 4.0 |
| Glycerol | 3.75 |
| Ethylene glycol | 1.25 |
| 2 Pyrrolidone 95% | 5.0 |
| Surfynol 440 | 0.6 |
| 1,2-Benzisothazolin-3-one | 0.015 |
| Acrylic latex | 4.0 |
| PEG 20K | 5.40 |
| DI Water | to 100 |

### Properties of Comparative Example Ink 2

| Properties | |
|---|---|
| Viscosity at 32° C. | 12.00 |
| Surface Tension D/cm | 33.29 |

### Comparative Example Ink 3

| Component | Formulation At 100% Active (Wt %) |
|---|---|
| Titanium Dioxide 1 | 12.0 |
| Glycerol | 3.75 |
| Ethylene glycol | 1.25 |
| 2 Pyrrolidone 95% | 5.0 |
| Surfynol 440 | 0.028 |
| 1,2-Benzisothazolin-3-one | 0.015 |
| Rovene 6102 | 4.0 |
| PEG 20K | 5.2 |
| DI Water | to 100 |

### Properties of Comparative Example Ink 3

| Properties | |
|---|---|
| Viscosity at 32° C. | 11.56 |
| Surface Tension D/cm | 34.43 |

### Comparative Example Ink 4

| Component | Formulation At 100% Active (Wt %) |
|---|---|
| Titanium Dioxide 1 | 10.0 |
| Titanium Dioxide 2 | 4.0 |
| Glycerol | 3.75 |
| Ethylene glycol | 1.25 |
| 2 Pyrrolidone 95% | 5.0 |
| Surfynol 440 | 0.030 |
| 1,2-Benzisothazolin-3-one | 0.015 |
| Rovene 6102 | 4.0 |
| PEG 20K | 5.40 |
| DI Water | to 100 |

### Properties of Comparative Example Ink 4

| Properties | |
|---|---|
| Viscosity at 32° C. | 11.62 |
| Surface Tension D/cm | 33.6 |

All inks were left standing for 1 week and at the end of this time visually observed and the degree of sedimentation visually evaluated as low, medium or high. The results are shown in the Table below.

| Ink | Degree of Sedimentation |
|---|---|
| Example Ink 1 | Low |
| Example Ink 2 | Low |
| Example Ink 3 | Low |
| Example Ink 4 | Low |
| Comparative Example Ink 1 | Medium |
| Comparative Example Ink 2 | Medium |
| Comparative Example Ink 3 | High |
| Comparative Example Ink 4 | High |

The improvement in sedimentation behaviour seen with the inks of the present invention can also be seen by diluting the supernatant of the ink after 1 week to 0.06% with water and determining the light transmission at various wavelengths between 380 nm and 700 nm. At all these wavelengths the Comparative Example Ink showed a significantly greater light transmission than any of the Example Inks due to the fact that in the Example Inks much more titanium dioxide remained in suspension in the ink. The results at 700 nm are shown below.

| Ink | Transmission of Light at 700 nm % |
|---|---|
| Example Ink 1 | 4.9 |
| Example Ink 2 | 12.7 |
| Example Ink 3 | 5.7 |
| Example Ink 4 | 15.6 |
| Comparative Example Ink 1 | 66.1 |
| Comparative Example Ink 2 | 88.5 |
| Comparative Example Ink 3 | 98.4 |
| Comparative Example Ink 4 | 96.7 |

Example inks 1 to 4 were successfully printed through a SG1024 re-circulating print head from FUJIFILM Dimatix onto a variety of substrates to give robust prints without causing any faceplate wetting.

1. An ink comprising:
(a) from 1 to 25 parts of titanium dioxide pigment;
(b) from 0 to 8 parts of a styrene butadiene latex binder;
(c) from 0 to 8 parts of a polyurethane latex binder;
(d) from 0 to 5 parts of a glycol selected from the group consisting of ethylene glycol, diethylene glycol, propylene glycol, dipropylene glycol or triethylene glycol;
(e) from 1 to 10 parts of 2-pyrrolidone;
(f) from 1 to 10 parts of glycerol;
(g) from 0.01 to 2 parts of an acetylenic surfactant;
(h) from 0.001 to 5 parts of biocide;
(i) from 0 to 10 parts of a viscosity modifier; and
(j) the balance to 100 parts water; provided that (b) plus (c) is greater than 0.

2. An ink as claimed in claim 1 wherein the titanium dioxide pigment comprises a surface treated titanium dioxide pigment.

3. An ink as claimed in claim 1 comprising 0 parts of the polyurethane latex binder.

4. An ink as claimed in claim 1 comprising 0 parts of the styrene butadiene latex binder.

5. An ink as claimed in claim 1 containing either the styrene butadiene latex binder in the range of from 2 to 6 parts or the polyurethane latex binder in the range of from 2 to 6 parts.

6. An ink as claimed in claim 1 wherein the glycol comprises ethylene glycol

7. An ink as claimed in claim 1 wherein the glycerol is present in the range of from 2 to 7.5 parts.

8. An ink as claimed in claim 1 wherein the acetylenic surfactant comprises 2,4,7,9-tetramethyl-5-decyne-4,7-diol.

9. An ink as claimed in claim 1 wherein the viscosity modifier comprises polyethylene glycol.

10. An ink as claimed in claim 1 comprising:
(a′) from 5 to 20 parts of titanium dioxide pigment;
(b′) from 2 to 6 parts of a styrene butadiene latex binder;
(c′) from 0.5 to 2.5 parts of ethylene glycol;
(d′) from 2.5 to 7.5 parts of 2-pyrrolidone;
(e′) from 2 to 7.5 parts of glycerol;
(f′) from 0.05 to 1.0 parts of 2,4,7,9-tetramethyl-5-decyne-4,7-diol;
(g′) from 0.001 to 2 parts of biocide;
(h′) from 3 to 8 parts of a viscosity modifier;
(i′) the balance to 100 parts water.

11. An ink as claimed in claim 1 comprising:
(a″) from 5 to 20 parts of titanium dioxide pigment;
(b″) from 2 to 6 parts of a polyurethane latex binder;
(c″) from 0.5 to 2.5 parts of ethylene glycol;
(d″) from 2.5 to 7.5 parts of 2-pyrrolidone;
(e″) from 2 to 7.5 parts of glycerol;
(f″) from 0.05 to 1.0 parts of 2,4,7,9-tetramethyl-5-decyne-4,7-diol;
(g″) from 0.001 to 2 parts of biocide;
(h″) from 3 to 8 parts of a viscosity modifier;
(i″) the balance to 100 parts water.

12. An ink-jet printing process wherein the ink according to claim 1 is printed onto a substrate using an ink-jet printer with an ink re-circulating print-head.

13. A substrate printed by an ink-jet printing process as described in claim 12.

14. An ink-jet printer ink container containing an ink as defined in claim 1.

15. (canceled)
